(19) United States
(12) Patent Application Publication
(10) Pub. No.: US 2026/0189654 A1
(43) Pub. Date: Jul. 2, 2026

(54) EMERGENCY RESPONDER DATA COMMUNICATION SYSTEM, APPARATUSES AND METHODS

(71) Applicant: RAPIDSOS, INC., New York, NY (US)

(72) Inventors: Michael Heneka, Fabius, NY (US); Zachery LaValley, Arlington, MA (US); James Patrick Olejar, JR., Fort Lauderdale, FL (US)

(21) Appl. No.: 19/005,380

(22) Filed: Dec. 30, 2024

(51) Int. Cl. H04M 3/51; G06N 20/00

(52) U.S. Cl. CPC H04M 3/5116; G06N 20/00; H04M 2203/10; H04M 2203/55

(57) ABSTRACT

A disclosed method implements: receiving, by a cloud server, unstructured computer-aided-dispatch (CAD) incident data from a CAD system corresponding to a CAD incident record for an emergency call received at an emergency communication center (ECC); performing entity extraction on the unstructured CAD incident data to generate output data; and sending the output data from the cloud-based server, to an emergency responder mobile device terminal to provide information related to the CAD incident record for the emergency call.

### CROSS-REFERENCE TO RELATED APPLICATIONS

None.

### FIELD OF THE DISCLOSURE

The present disclosure relates generally to enhanced 9-1-1 (E911) and next generation 9-1-1 (NG911) emergency networks and more particularly to computer-aided-dispatch (CAD), and systems, apparatuses, and methods used by emergency responders in responding to emergencies.

### BACKGROUND

An Emergency Communication Center (ECC) is defined by the National Emergency Number Association (NENA) as “A set of call takers operating under common management which receives emergency calls for service and asynchronous event notifications and processes those calls and events according to a specified operational policy.” A specific type of ECC is a Public Safety Answering Point (PSAP) which NENA defines as an entity responsible for receiving 9-1-1 calls and processing those calls according to a specific operational policy.

ECC call takers utilize various software systems including call handling and call taking software, and computer-aided-dispatch (CAD) systems. Nena defines CAD as “A computer-based system, which aids PSAP Telecommunicators by automating selected dispatching and record keeping activities.” CAD systems are used to respond to a call for service (CFS) (also referred to as an “emergency call”) by creating a corresponding “incident” record, and dispatchers use the CAD system information to dispatch emergency responders to the incident address.

Data points related to Emergency Response, including things like traffic stops, may come through various formats such as audio format or other supplemental data, or may be digital requests for assistance without audio such as alarm calls and SMS messaging. Calls for service from the community come in via telephone calls to 9-1-1 (or telephone calls to a 10-digit administrative line) into the ECC. An ECC telecommunicator then interacts and interrogates the caller for additional information, gleans what is appropriate for the necessary response type, and then inputs that information into a computer aided dispatch (CAD) system, usually via a CAD incident form within a CAD graphical user interface (GUI). The type of information recorded into the CAD incident form may include caller name, caller phone number, caller address, incident address, a narrative pertaining to the incident, additional historical information about that location and any relevant site hazards associated with that address.

CAD systems also record the status of every emergency responder unit that is in service during that particular shift. Such units may include law enforcement, fire service, Emergency Medical Services (EMS), etc. The ECC telecommunicator then selects the most appropriate resource/unit for the incident type to be dispatched, and then assigns that unit to that incident. This starts the dispatch process.

When a call for service is received, the telecommunicator assigns the appropriate emergency responder unit responsible for that jurisdiction to respond to that incident, thus being “dispatched”. The telecommunicator then keys the radio to transmit that information in audio format, or sends it digitally via a mobile data terminal (MDT), to the emergency responder unit to initiate “response.” The emergency responder, either through the mobile data terminal or over the radio, advises that they are “en route” to that location, or they may reassign to another unit.

After units are dispatched, new information may come in from the emergency responders in the field. The telecommunicator may then update the CAD incident record with this new information. There may also be information about the location of the emergency responder based upon AVL (automatic vehicle locating) system location or body camera locations. Additionally, information is gleaned via radio or MDT transmissions concerning the vehicle the emergency responder is approaching. All of this information can be useful to the emergency responder and to other emergency responders in the field.

### BRIEF DESCRIPTION OF THE DRAWINGS

FIG. 1 is a diagram of an Emergency Communication Center (ECC) computer-aided-dispatch (CAD) system in communication with a cloud-based emergency responder data communication system in accordance with an embodiment. The ECC may be a Public Safety Answering Point (PSAP).

FIG. 2 is a diagram of a cloud-based emergency responder data communication system in communication with emergency responder mobile data terminals (MDTs), and various emergency reporting systems in accordance with an embodiment.

FIG. 3 is a flowchart of a method of operation of a cloud-based emergency responder data communication system in accordance with an embodiment.

FIG. 4 is a flowchart of a method of operation of a cloud-based emergency responder data communication system in accordance with an embodiment.

FIG. 5 is a flowchart of a method of operation of a cloud-based emergency responder data communication system in accordance with an embodiment.

FIG. 6 is a flowchart of a method of operation of a cloud-based emergency responder data communication system in accordance with an embodiment.

FIG. 7 is a block diagram of another machine learning training scheme for an AI module of an emergency data management system, in accordance with an embodiment.

FIG. 8 is a flowchart of a method of operation for machine learning training in accordance with an embodiment corresponding to FIG. 7, and for generating a script to process ECC CAD incident data.

FIG. 9 is a is a flowchart of a method of operation or machine learning training in accordance with an embodiment corresponding to FIG. 7, and for generating a script to process ECC CAD incident data.

### DETAILED DESCRIPTION

Briefly, a cloud-based emergency responder data communication system is operative to receive unstructured computer-aided-dispatch (CAD) incident data from a CAD system corresponding to a CAD incident record for an emergency call received at an emergency communication center (ECC), analyze the data an provide emergency responders in the field with dynamically updated information related to the CAD incident record for the emergency call. The system is also operative to generate fire incident reports and patient care reports from using the CAD incident data and updates received from the field.

A disclosed method implements: receiving unstructured computer-aided-dispatch (CAD) incident data from a CAD system corresponding to a CAD incident record for an emergency call received at an emergency communication center (ECC); performing entity extraction on the unstructured CAD incident data to generate output data; and sending the output data from the cloud server, to an emergency responder mobile device terminal to provide information related to the CAD incident record for the emergency call.

The method may further implement: formatting at least a portion of the output data to generate formatted data; and sending the formatted data from the cloud server to the emergency responder mobile device terminal to provide information related to the CAD incident record for the emergency call. The method may further implement generating a fire incident report using the output data. The method may further implement generating a patient care report using the output data. In some embodiments, performing entity extraction on the unstructured CAD incident data to generate output data, may include: analyzing the unstructured CAD incident data using an artificial intelligence model; and performing entity extraction on the unstructured CAD incident data by the artificial intelligence model.

Another disclose method implements: receiving, by a cloud server, unstructured computer-aided-dispatch (CAD) incident data from a CAD system corresponding to a CAD incident record for an emergency call received at an emergency communication center (ECC); generating output data by an artificial intelligence model based on analyzing the unstructured CAD incident data; and sending the output data from the cloud server, to an emergency responder mobile device terminal to provide information related to the CAD incident record for the emergency call.

The method may further implement: formatting at least a portion of the output data to generate formatted data; and sending the formatted data from the cloud server to the emergency responder mobile device terminal to provide information related to the CAD incident record for the emergency call. The method may further implement generating, by the artificial intelligence model, a fire incident report using the output data. The method may further implement generating, by the artificial intelligence model, a patient care report using the output data. In some embodiments, generating output data by an artificial intelligence model may include performing entity extraction on the unstructured CAD incident data by the artificial intelligence model. In some embodiments, generating output data by an artificial intelligence model may include analyzing the unstructured CAD incident data by a large language model. Generating output data by an artificial intelligence model may involve analyzing the unstructured CAD incident data by a generative pre-trained transformer (GPT) model.

A disclosed emergency responder communication system includes a cloud server, operative to: connect to a computer-aided-dispatch (CAD) system located at an emergency communication center (ECC) via a network connection; receive unstructured computer-aided-dispatch (CAD) incident data therefrom; and send output data to an emergency responder mobile device terminal to provide information related to a CAD incident record for an emergency call received by the ECC and corresponding to the CAD incident data. The system further includes an artificial intelligence module, operative to execute an artificial intelligence model that is operative to generate the output data based on analyzing the unstructured CAD incident data.

The artificial intelligence model may be further operative to: format at least a portion of the output data to generate formatted data, wherein the formatted data is sent from the cloud server to the emergency responder mobile device terminal to provide information related to the CAD incident record for the emergency call. The artificial intelligence model may be further operative to generate a fire incident report using the output data. The artificial intelligence model may be further operative to generate a patient care report using the output data. The artificial intelligence model may be further operative to perform entity extraction on the unstructured CAD incident data.

In some embodiments, the artificial intelligence model is a large language model. In some embodiments, the artificial intelligence model is a generative pre-trained transformer (GPT) model. In some embodiments, the system further includes a virtual private cloud, operatively coupled to the cloud server, wherein the artificial intelligence model is hosted within the virtual private cloud.

Another disclose method implements: training an artificial intelligence module in a cloud-based emergency responder communication system using training data comprising computer-aided-dispatch (CAD) incident data from an emergency communication center (ECC); generating a script, in response to the training data, by the artificial intelligence module, the script for converting CAD incident data into a format useable by an emergency responder mobile device terminal application; and configuring a cloud-based processor using the script.

The method may further implement: receiving CAD incident data, corresponding to a CAD incident at an emergency communication center (ECC), at a cloud server; sending the CAD incident data and the script to an artificial intelligence model; receiving output data from the artificial intelligence model in response to processing the CAD incident data in response to the script; and sending the output data to an emergency responder mobile device terminal to provide information about the CAD incident.

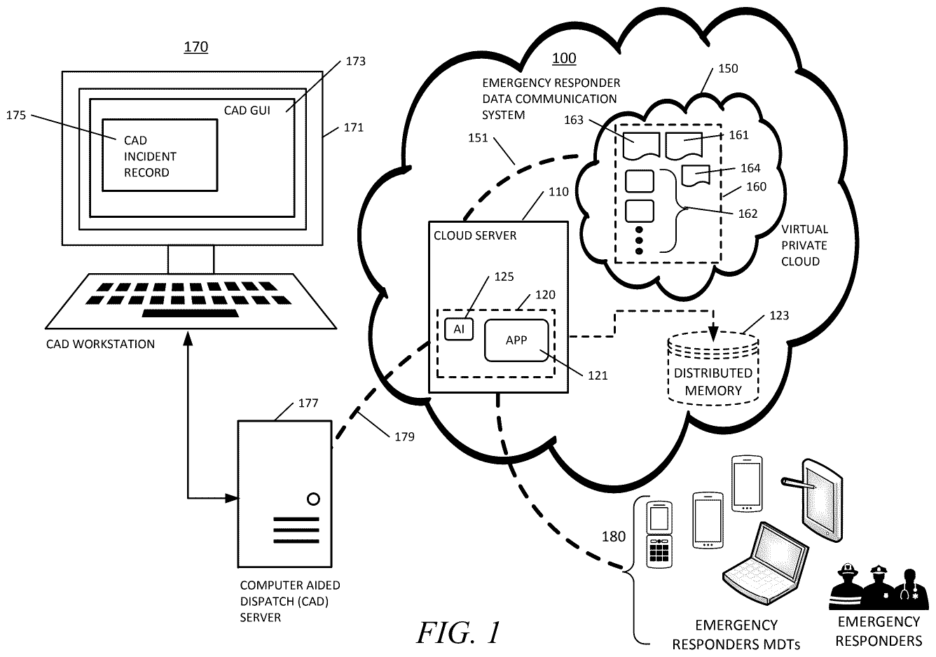

Turning now to the drawings wherein like numerals represent like components, FIG. 1 is a diagram of an Emergency Communication Center (ECC) computer-aided-dispatch (CAD) system 170 that is in communication with a cloud-based emergency responder data communication system 100 that includes a cloud server 110 and a virtual private cloud 150 hosting various artificial intelligence models (AI models 162) executed by distributed processing 160 in accordance with an embodiment. The AI models 162 may be invoked using an API 151 and sending instructions 161 and user data 163 provided by the cloud server 110. The AI models 162 provide the output data 164 to the cloud server 110. The ECC may be a Public Safety Answering Point (PSAP). The cloud server 110 includes at least one processor 120 which may be a distributed processor. The cloud server 110 is operatively coupled to a non-volatile, non-transitory, distributed memory 123 which stores executable code (executable instructions).

The processor 120 may be implemented as one or more microprocessors, such as a system on a chip (SoC), or using one or more, or combinations of, graphics processing units (GPUs), ASICs such as tensor processing units (TPUs), FPGAs, microcomputers, microcontrollers, digital signal processors, central processing units, state machines, logic circuitries, and/or devices that manipulate signals based on operational instructions. Among other capabilities, the processor 120 is configured and operative to fetch and execute the computer-readable instructions (i.e. executable code) stored in the distributed memory 123. For example, the executable code, when executed by the processor 120 renders the processor operative to provide a kernel, libraries (i.e. application programming interfaces or “APIs”), an application layer or “user space” within which the various applications are executed, and an IP protocol stack. The executable code, when executed by the at least one processor 120, provides the cloud application 121, and an AI module 125. The processor 120 is operative to perform the various methods of operation as described herein including, but not limited to, the methods of operation disclosed herein and described with respect to various flowcharts provided in the drawings. In some embodiments, the emergency responder data communication system 100 may be implemented using one or more cloud servers 110 that provide the cloud application 121 to various ECCs such that there is redundancy and system reliability in the event of failure of any one cloud server.

The at least one processor 120 is operative to execute the executable code stored in distributed memory 123, to implement the cloud application 121, which is further operative to communicate with CAD server 177 and to interface with a CAD software system implemented on the CAD server 177. The cloud application 121 may communicate with the CAD software system via an API 179 implemented over an Internet connection, or via a locally installed component of the application installed on the CAD server 177 also in communication with the cloud server 110 via an Internet connection. The at least one processor 120 may also execute one or more AI models stored in distributed memory 123 to implement AI module 125, which may receive and process data from the CAD server 177.

The CAD system 170 is used by the ECC to respond to a call for service (CFS) (also referred to as an “emergency call”) by creating a corresponding CAD incident record 175 using a CAD GUI 173, and dispatchers use the CAD system 170 information to dispatch emergency responders to an incident address. The term “call” as used herein comports with the NENA definition as “a generic term used to include any type of Request For Emergency Assistance (RFEA); and is not limited to voice.” Therefore, the term “call” may include a session established by signaling with two-way real-time media and involves a human making a request for help.” The terms “voice call”, “video call” or “text call” are used herein when the specific media is of significance. As per NENA definitions, the term “call” may refer to either a “voice call”, “video call”, “text call” or “data-only call”, since they are handled the same way through most of NG9-1-1.”

A definition of the term “incident” is provided by APCO International. The Association of Public-Safety Communications Officials (APCO) International is the world's oldest and largest organization of public safety communications professionals, and generates standards related to public safety. One example APCO International standard is “Public Safety Communications Common Incident Types For Data Exchange,” APCO 2.103.2-2019. This standard defines the term “incident” as a “real world event such as a motor vehicle accident, structure fire or illness.” “Incidents may be declared by an ECC or by a unit reporting from the field.” Regarding CAD systems, the standard also defines an “incident type code” as “an acronym or other abbreviated combination of alphanumeric characters used to describe the nature of the real-world event that is being reported.” “Incident type codes typically differ between disparate ECCs and public safety agencies.”

CAD system 170 operators are often referred to as “dispatchers” who operate the CAD workstation 171 to dispatch emergency responders to the location of an emergency and manage vehicles and personnel. Depending on the size of an ECC, personnel may work as both call takers and dispatchers. In that situation an ECC operator may serve as a call taker and as a dispatcher and may have access to call taking software as well as CAD software. In larger metro areas, call taking is a separate function from dispatcher and when a call taker receives a CFS (i.e. emergency call) the call taker will communicate verbally with a dispatcher to convey information related to the emergency call. The dispatcher may then access the CAD software via the CAD GUI 173, to create an incident and populate a specialized form (such as CAD incident record 175) selected to correspond to the incident based on an incident type code as described in the APCO International standard discussed above.

As dispatchers dispatch emergency responders to the incident location, further information is received from the emergency responders and, in some cases, from the emergency caller. The dispatcher, or call taker, updates the incident record 175 as information is received. This is a manual process of data entry using the CAD workstation 171. Each ECC may use its own incident forms and may require unique incident information specific for the particular ECC. CAD incident records may include hundreds of lines of textual information that includes some information manually entered by personnel, and some information populated from the call handling system such as ANI/ALI data (Automatic Number Identification/Automatic Location Identification data). The CAD system uses various types of data for various purposes. Each CAD incident form, that corresponds to an incident type having an incident type code as described in the APCO International standard discussed above, may include unique data specific to the incident type. For example, an “industrial accident” (incident code “ACCIND”) may have data related to an involved factory, machinery, hazardous materials involved or other related information. A medical emergency such as a “cardiac related event” (incident code CARDIA) may have medical data related to the specific patient. Each incident code will have specific data related to that specific incident.

Another example of CAD system data is AVL data. CAD systems generally provide operators with a view to AVL data, (Automatic Vehicle Location data), and NENA defines AVL as “A means for determining the geographic location of a vehicle and transmitting this information to a point where it can be used.” More particularly, AVL data is information that is used the CAD system operators to track the location of vehicles, such as police cars, fire department vehicles, and ambulances, etc., in real-time.

AVL data may be generated by a Global Positioning System (GPS) or other location tracking systems that are installed within emergency responder vehicles. The AVL data may include, for example, a current location of a vehicle, as well as information about its speed, direction, and other information. A CAD workstation may display a map with layers of AVL data, among other layers, that therefore can be used to track the location and status of emergency responder vehicles in real-time, to provide dispatchers with information about the availability and location of resources, and to quickly see the location and status of all vehicles in the fleet. ECC dispatchers can thus use AVL information to make informed decisions about how to best deploy vehicles and personnel in response to emergency calls, alarms, etc. Reports and analytics may also be generated using AVL data, which can be used to improve the ECC operating efficiency and effectiveness, among other uses.

The ECC may obtain AVL data via a variety of networks, and emergency responder vehicles may for example, have an AVL system that is connected to a wireless modem or other device that is operative to transmit the data to the ECC over a wireless network. The wireless networks employed may be, but are not limited to: cellular networks including 5G networks, satellite networks, Wi-Fi networks, or ECC propriety wireless networks, etc. Intake of the AVL data by the ECC may then be through equipment located within the ECC CPE that is connected to the ECC local area network (LAN).

In one embodiment, any and all CAD incident data from the CAD incident record 175, including CAD incident updates, flows from the CAD server 177 to the cloud server 110 using the API 179 (or via the cloud application 121 with a component resident on the CAD server 177) and the cloud-server 110 passes the CAD incident data (as user data 163), along with instructions 161, to the virtual private cloud 150. An API 151 is utilized between the cloud server 110 and the virtual private cloud 150. The API 151 is used to send the CAD incident data and instructions as a data object which may be a JSON (JavaScript Object Notation) object in some implementations. The data object may include the instructions 161 and the user data 163 and may invoke one or more AI models 162 as resources to analyze the CAD incident data and to analyze it and provide the output data 164 as needed for the emergency responder MDTs 180, as well as for other purposes.

The AI models 162 may include generative AI models such as, but not limited to, generative pre-trained transformers (GPT), bidirectional encoder representations from transformers (BERT), ELECTRA, XLNet, T5, and the like, etc. One or more of the AI models 162 may implement a GPT such as a large language model (LLM) in some embodiments. In some embodiments, the AI module 125 may interface with a GPT, or other of the AI models 162, via one or more application programming interfaces such as API 151. The instructions 161 may be code (such as Python code), text prompts or a combination of both, and may be provided as a JSON object as discussed above.

In some embodiments, the AI module 125 may be implemented as an AI server with one or more GPUs that are designed specifically to accommodate training and utilization of AI deep learning models such as LLMs and GPTs. The AI server in such embodiments may be installed at an ECC or may be located with the cloud server 110 equipment. In some embodiments, the AI module 125 may be implemented as an AI server that includes one or more GPU servers that are designed specifically to accommodate training and utilization of AI deep learning models, and various machine learning models. The one or more GPU servers may, in some embodiments, be installed at an infrastructure operations center location or may be installed at an ECC location or a combination of both. In some embodiments, the GPU servers may be cloud-based and form part of the emergency responder data communication system 100 cloud-infrastructure or may be ancillary cloud-based servers operatively coupled to the cloud server 110.

Any utilized machine learning models may be updated from time-to-time using new or additional training data, or may be updated using reinforcement learning from human feedback (RLHF) in order to optimize the machine learning models.

In some embodiments, the AI module 125 may implement the one or more AI models 162 at the cloud server 110, and the virtual private cloud 150 may not be present (i.e. may not be required in all implementations). In such embodiments, the AI module 125 may implement various machine learning models and may include an LLM which may further be a GPT. In that case, the AI module 125 would receive and process the instructions 161 and the user data 163 to produce the output data 164. The machine learning models 162, whether implemented within the virtual private cloud 150 or via the AI module 125, may include, but are not limited to, regression, decision trees, random forests, LLMs, diffusion models, etc. to perform some, or all of these techniques as appropriate for the received CAD data inputs. Therefore, in accordance with the embodiments, various machine learning models as well as generative AI may be used in combination to achieve the results of the embodiments herein described. In various embodiments, the API 179, the API 151, or both may be a RESTful API, and may utilize RESTful API HTTP methods such as GET, POST, PUT, and DELETE. Therefore, the cloud server 110 may use any of the RESTful API HTTP methods such as GET, POST, PUT, and DELETE to handle data from the CAD server 177, as well as to and from the virtual private cloud 150.

In the example embodiment of FIG. 1, the distributed processing 160 executes one or more of the AI models 162 and processes the instructions 161 and user data 163 received from the cloud server 110 via the API 151 The instructions 161 may be a prompt including a system message portion and an instructions portion such as a one-shot, few-shot, or chain-of-thought prompt for an LLM. The instructions may be formatted as a JSON object and may utilize code such as Python code.

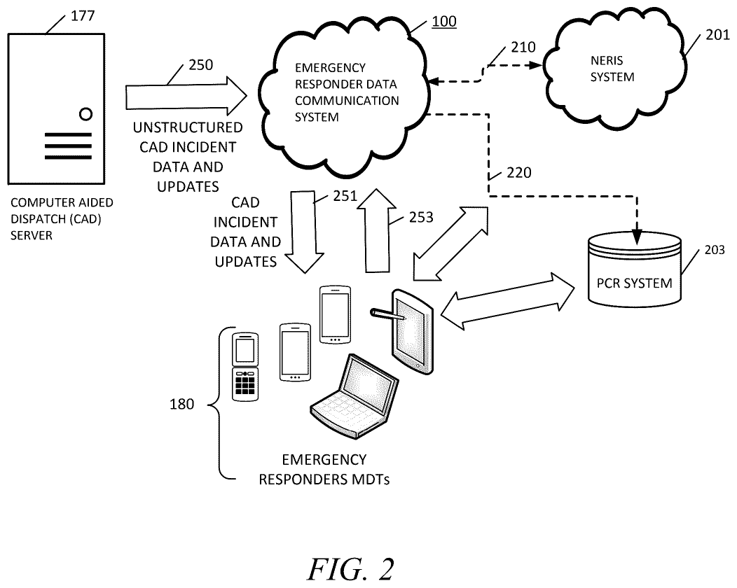

FIG. 2 is a diagram showing interoperation and interoperability of the emergency responder data communication system 100 with various ECC and other systems. The CAD server 177 sends CAD incident data and updates 250 to the emergency responder data communication system 100, which processes the data using one or more AI models. Analyzed, processed, and formatted CAD incident data and updates 251 is sent to emergency responder MDTs 180 for display on a mobile application such that the emergency responders have a full view into an incident.

The emergency responder data communication system 100 also provides appropriate data and updates 210 to a NERIS system 201 and PCR data 220 to a PCR system 203. The National Emergency Response Information System (NERIS) is a secure cloud-hosted platform being developed and launched by the U.S. Fire Administration (USFA). The NERIS system 201 provides emergency responders with real-time information and decision-making tools, including analytics, and is a replacement for the National Fire Incident Reporting System (NFIRS) system. The PCR system 203 records “Patient Care Reports.” A PCR (Patent Care Report) is used in the healthcare practice known as “PCR charting” in which patient care provided by emergency responders (also referred to as emergency medical services (EMS) personnel) is documented. The PCR serves as a legal document that provides details regarding the patient's condition, assessment, interventions taken, and vital signs during an emergency call. Put another way, a PCR is a written record of the care given to a patient during a response to an emergency call, which may also involve transport of the patient to a hospital.

In some embodiments, the emergency responder MDTs 180 may send updates 253 directly to the emergency responder data communication system 100 via an app installed on the MDTs 180, or using a browser interface to the cloud application 121. The updates 253 may include data related to the NERIS system 201 or to the PCR systems 203. In other embodiments, the MDTs 180 may send updates to the CAD server 177 which then provides that information to the emergency responder data communication system 100 as CAD incident data and updates 250. In that implementation, the cloud server 110 handles the data via either processing it locally using the AI module 125, or using the AI models 162. The data received from the CAD server 177 and from MDTs 180, is unstructured data in that it is typically text based data and has no particular format.

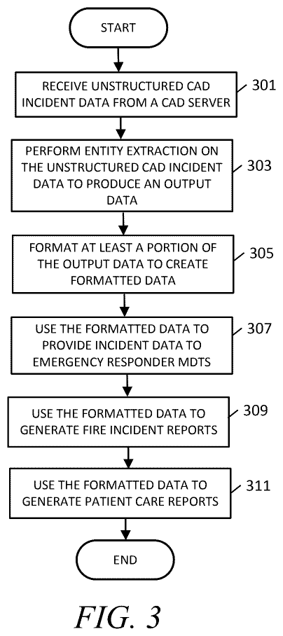

FIG. 3 is a flowchart of a method of operation in accordance with an embodiment of the emergency responder data communication system 100 for handling the unstructured data to provide critical information to MDTs 180 and other reporting systems such as the NERIS system 201 and PCR system 203. At operation 301, the emergency responder data communication system 100 receives unstructured CAD incident data as user data 163 from the CAD server 177. The unstructured CAD incident data corresponds to a CAD incident record 175 related to an emergency call coming into the ECC. At operation 303, the emergency responder data communication system 100 performs operations on the user data 163 such as, but not limited to, entity extraction, categorization, natural language processing, sentiment analysis, image analysis and summary, etc., and the like. At operation 305, the emergency responder data communication system 100 formats at least a portion of the data to create formatted data. At operation 307, the emergency responder data communication system 100 uses the formatted data to provide incident data to the emergency responder MDTs 180. At operation 309, the emergency responder data communication system 100 uses the formatted data to generate fire incident reports for the NERIS system 201, and at operation 311 the emergency responder data communication system 100 uses the formatted data to provide patient care reports for the PCR system 203.

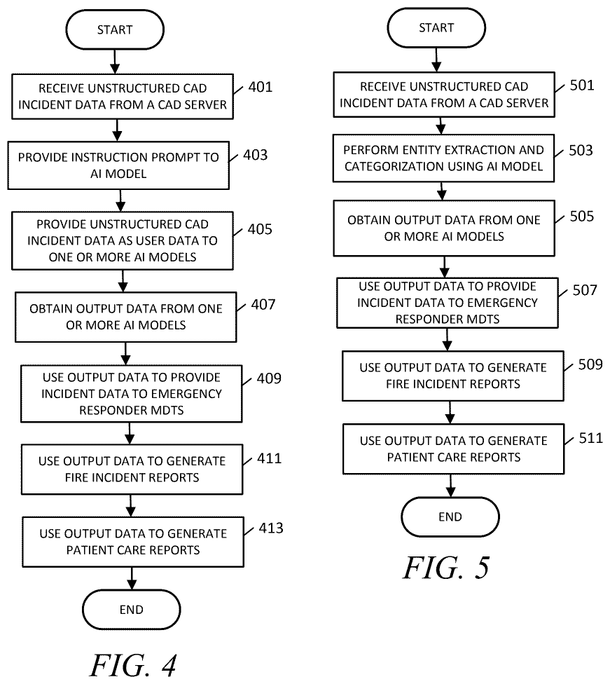

FIG. 4 is a flowchart of a method of operation in accordance with an embodiment of the emergency responder data communication system 100 for handling the unstructured data to provide critical information to MDTs 180 and other reporting systems such as the NERIS system 201 and PCR system 203. At operation 401, the cloud server 110 receives unstructured CAD incident data as user data 163 from the CAD server 177. The unstructured CAD incident data corresponds to a CAD incident record 175 related to an emergency call coming into the ECC. At operation 403, the cloud server 110 provides an instruction prompt to one or more AI models. The instruction prompt may be in the form of a JSON object and may include code elements, such as Python code. The instruction prompt may be a prompt type such as a zero-shot, few-shot, or chain-of-thought prompt. Multiple instruction prompts for multiple AI models may be utilized and each AI model may be prompted using a different prompt type depending on the required analysis task. In some embodiments, a single JSON object may contain multiple prompt types related to multiple tasks assigned to a single AI model such as an LLM. At operation 405, the cloud server 110 provides the unstructured CAD incident data as user data 163 to cloud distributed processing 160 to execute one or more AI models 162. The cloud server 110 uses API 151 to send the user data 163 and instructions 161. One or more AI models 162 process the user data 163 by analyzing it, and producing the output data 164. The output data 164 may be produced by performing operations on the user data 163 such as, but not limited to, entity extraction, categorization, natural language processing, sentiment analysis, image analysis and summary, etc., and the like.

At operation 407, the cloud server 110 obtains the output data 164 from the one or more AI models that performed processing on the user data 163. At operation 409, the cloud server 110 uses the output data to provide incident data to the emergency responder MDTs 180. At operation 411, the cloud server 100 uses the output data to generate fire incident reports for the NERIS system 201, and at operation 413 the cloud server 100 uses the output data to provide patient care reports for the PCR system 203.

Turning to the method of operation illustrated by the flowchart of FIG. 5, at operation 501, the emergency responder data communication system 100 receives unstructured CAD incident data from the CAD server 177. At operation 503, the emergency responder data communication system 100 performs entity extraction and categorization operation on the unstructured CAD incident data using at least one AI model. The AI model may be an LLM. At operation 505, the emergency responder data communication system 100 obtains output data from one or more AI models. At operation 507, the cloud server 100 uses the output data to provide incident data to the emergency responder MDTs 180. At operation 509, the cloud server 100 uses the output data to generate fire incident reports for the NERIS system 201, and at operation 511 the cloud server 100 uses the output data to provide patient care reports for the PCR system 203.

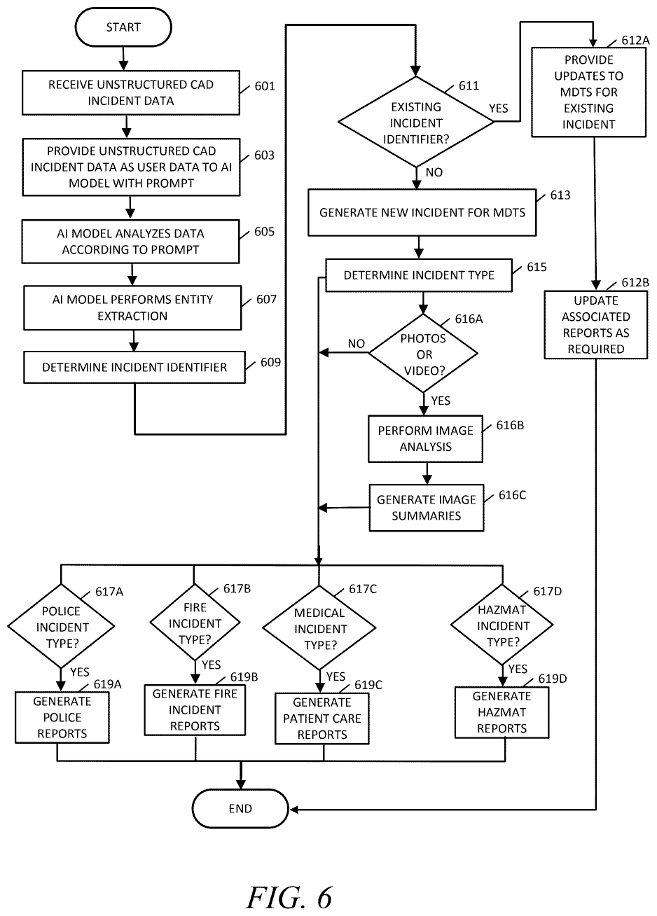

Turning to the method of operation illustrated by the flowchart of FIG. 6, at operation 601, the emergency responder data communication system 100 receives unstructured CAD incident data from the CAD server 177. At operation 603, the emergency responder data communication system 100 provides the unstructured CAD incident data as user data 163 to an AI model along with a prompt as instructions 161. The prompt may be a zero-shot, few-shot, or chain-of-thought type prompt or combinations thereof and may include code such as Python code. The prompt may be in the form of a JSON object. The prompt and user data may be provided to the AI model via an API call using API 151. At operation 605, an AI model analyzes the user data 163 according to the prompt or prompts provides as instructions 161. At operation 607, the AI model performs entity extractions and at operation 609 determines an incident identifier. If the incident identifier is an existing incident identifier at decision 611, then at operation 612A the emergency responder data communication system 100 provides updates to the emergency responder MDTs 180 for the existing incident and at operation 612B updates any associated reports as required.

If the determined incident identifier is not an existing incident identifier at decision 611, then at operation 613 the emergency responder data communication system 100 provides the new incident to the MDTs 180 and determines the incident type at operation 615. If the CAD incident data includes photos or images at decision 616A, then at operation 616B one or more AI models performs image analysis and at operation 616C text image summaries of the photos or video may be generated. If no photos or videos are detected at decision 616A, then the incident determination proceeds with a police incident at decision 617A, a fire incident at decision 617B, a medical incident at decision 617C, or a hazardous materials (hazmat) incident at decision 617D. Depending upon the incident type, the emergency responder data communication system 100 generates police reports as in operation 619A, fire incident reports as in operation 619B, patient care reports as in operation 619C, or hazmat reports as in operation 619D, as appropriate for the incident.

Instructions 161 sent to the AI model may include various parameter settings such as, but not limited to, parameter settings for an LLM such as temperature, top-p, frequency penalty, presence penalty, max tokens, context window, stop sequences, number of tokens, and various other hyperparameters, etc. In one example, for a categorization entity extraction the temperature setting may be set to zero. The prompts used in the emergency responder data communication system 100 may be evaluated prior to deployment using previous CAD incident data obtained over weeks, months, or years. Golden examples may be extracted and used to determine various evaluation metrics depending on the tasks for which an LLM is prompted. For example, an entity extraction or categorization task may be evaluated using golden examples to obtain a micro F1 score or the like, etc. and optimized based on micro F1 scores or the like, etc.

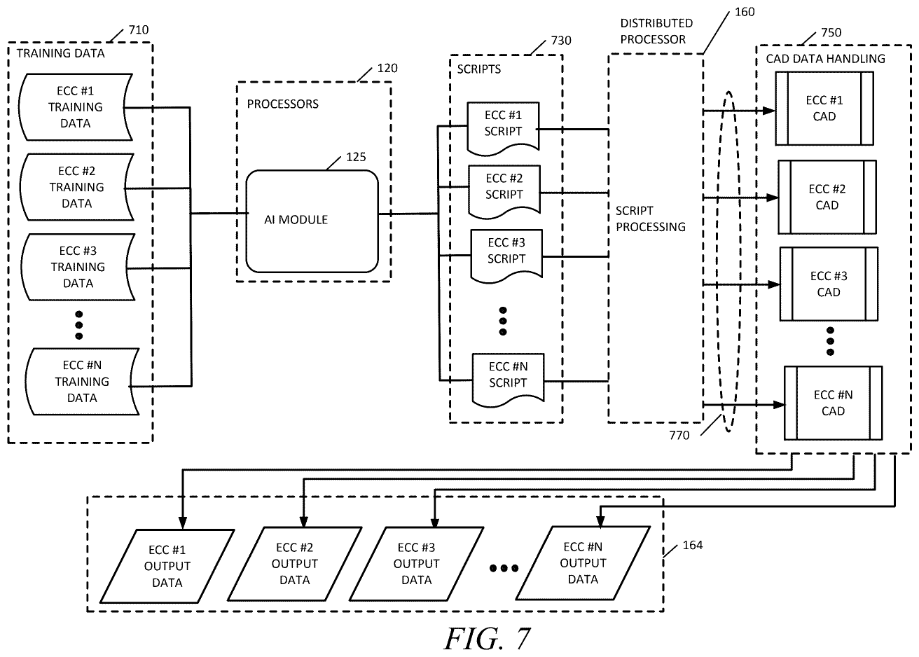

FIG. 7 is a block diagram of a training scheme for an artificial intelligence module of an emergency responder data communication system 100, in accordance with another embodiment. In the embodiment example of FIG. 7, the AI module 125 is trained to create a script for handling CAD incident data from various ECC CAD systems. The AI module 125 is trained for each ECC that provides training data, and produces an ECC CAD data handling script 730 as a result of the training. The training data includes CAD incident data from each ECC over a period of time. The ECC scripts 730, when executed, configure the distributed processing 160 to implement a CAD data handling subprocess 750 for each ECC, to extract data from unstructured CAD incident data and updates 250, (which may be received via an API 770) analyze and format the CAD incident data and updates 250 into output data 164 which is in a format useable by emergency responder MDTs 180, the NERIS system 201, or the PCR system 203 as appropriate.

The ECC scripts 730 are sent to the distributed processing 160 as part, or all, of instructions 161 for each ECC, along with CAD incident data as user data 163, to process and analyze the CAD incident data.

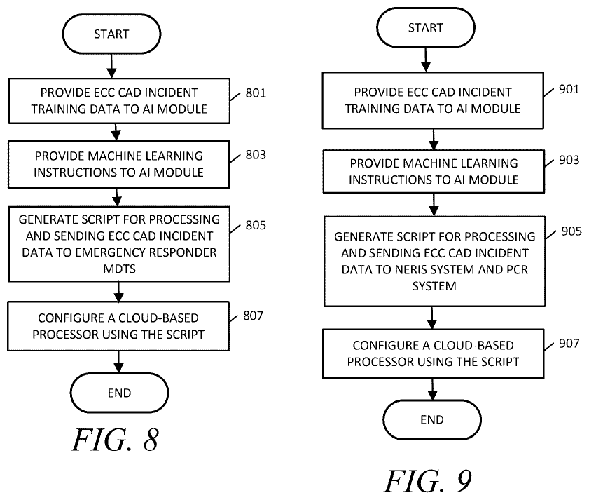

FIG. 8 is a flowchart of a method of operation for machine learning training in accordance with an embodiment corresponding to FIG. 7, and for generating a script to process ECC CAD incident data. At operation 801 ECC training data 710 is provided to the AI module 125. The ECC training data 710 is CAD incident data from an ECC CAD system over a period of time such as, days, weeks, or years, etc. as available. At operation 803, machine learning instructions are provided to the AI module 125. The AI module 125, may implement a large language model (LLM) in some embodiments. The machine learning instructions may be code, prompts or a combination of both. At operation 805, the AI module generates an ECC script 730 for processing and CAD incident data and sending output data 164 to the appropriate emergency responder MDTs 180. The ECC scripts are generated using machine learning and may be generated by generative AI. At operation 807, the ECC script is used as all or part of instructions 161 to configure a cloud-based processor such as distributed processing 160, such that the cloud-based processor is operative to generate the relevant output data 164 for the emergency responder MDTs 180.

FIG. 9 is a flowchart of a method of operation for machine learning training in accordance with an embodiment corresponding to FIG. 7, and for generating a script to process ECC CAD incident data. At operation 901 ECC training data 710 is provided to the AI module 125. The ECC training data 710 is CAD incident data from an ECC CAD system over a period of time such as, days, weeks, or years, etc. as available. At operation 903, machine learning instructions are provided to the AI module 125. The AI module 125, may implement a large language model (LLM) in some embodiments. The machine learning instructions may be code, prompts or a combination of both. At operation 905, the AI module generates an ECC script 730 for processing and CAD incident data and generating output data 164 for the NERIS system 201, the PCR system 203, or both as appropriate. The ECC scripts 730 are generated using machine learning and may be generated by generative AI. At operation 907, the ECC script 730 is used as all or part of instructions 161 to configure a cloud-based processor such as distributed processing 160, such that the cloud-based processor is operative to generate relevant output data 164 for the NERIS system 201, the PCR system 203, or both as appropriate.

The example embodiment shown in FIG. 7 utilizes the AI module 125 for generation of the ECC CAD data handling scripts 730, however, in some embodiments, one or more of the AI models 162 in the VPC 150 could also be utilized for this purpose.

While various embodiments have been illustrated and described, it is to be understood that the invention is not so limited. Numerous modifications, changes, variations, substitutions and equivalents will occur to those skilled in the art without departing from the scope of the present invention as defined by the appended claims.

What is claimed is:

1. A method comprising:
receiving, by a cloud server, unstructured computer-aided-dispatch (CAD) incident data from a CAD system corresponding to a CAD incident record for an emergency call received at an emergency communication center (ECC);
performing entity extraction on the unstructured CAD incident data to generate output data; and
sending the output data from the cloud server, to an emergency responder mobile device terminal to provide information related to the CAD incident record for the emergency call.

2. The method of claim 1, further comprising:
formatting at least a portion of the output data to generate formatted data; and
sending the formatted data from the cloud server to the emergency responder mobile device terminal to provide information related to the CAD incident record for the emergency call.

3. The method of claim 1, further comprising:
generating a fire incident report using the output data.

4. The method of claim 1, further comprising:
generating a patient care report using the output data.

5. The method of claim 1, wherein performing entity extraction on the unstructured CAD incident data to generate output data, comprises:
analyzing the unstructured CAD incident data using an artificial intelligence model; and
performing entity extraction on the unstructured CAD incident data by the artificial intelligence model.

6. A method comprising:
receiving, by a cloud server, unstructured computer-aided-dispatch (CAD) incident data from a CAD system corresponding to a CAD incident record for an emergency call received at an emergency communication center (ECC);
generating output data by an artificial intelligence model based on analyzing the unstructured CAD incident data; and
sending the output data from the cloud server, to an emergency responder mobile device terminal to provide information related to the CAD incident record for the emergency call.

7. The method of claim 6, further comprising:
formatting at least a portion of the output data to generate formatted data; and
sending the formatted data from the cloud server to the emergency responder mobile device terminal to provide information related to the CAD incident record for the emergency call.

8. The method of claim 6, further comprising:
generating, by the artificial intelligence model, a fire incident report using the output data.

9. The method of claim 6, further comprising:
generating, by the artificial intelligence model, a patient care report using the output data.

10. The method of claim 6, wherein generating output data by an artificial intelligence model, comprises:
performing entity extraction on the unstructured CAD incident data by the artificial intelligence model.

11. The method of claim 6, wherein generating output data by an artificial intelligence model, comprises:
analyzing the unstructured CAD incident data by a large language model.

12. The method of claim 6, wherein generating output data by an artificial intelligence model, comprises:
analyzing the unstructured CAD incident data by a generative pre-trained transformer (GPT) model.

13. An emergency responder communication system comprising:
a cloud server, operative to:
connect to a computer-aided-dispatch (CAD) system located at an emergency communication center (ECC) via a network connection;
receive unstructured computer-aided-dispatch (CAD) incident data therefrom;
send output data to an emergency responder mobile device terminal to provide information related to a CAD incident record for an emergency call received by the ECC and corresponding to the CAD incident data; and
an artificial intelligence module, operative to execute an artificial intelligence model, the artificial intelligence model operative to:
generate the output data based on analyzing the unstructured CAD incident data.

14. The emergency responder communication system of claim 13, wherein the artificial intelligence model is further operative to:
format at least a portion of the output data to generate formatted data, wherein the formatted data is sent from the cloud server to the emergency responder mobile device terminal to provide information related to the CAD incident record for the emergency call.

15. The emergency responder communication system of claim 13, wherein the artificial intelligence model is further operative to:
generate a fire incident report using the output data.

16. The emergency responder communication system of claim 13, wherein the artificial intelligence model is further operative to:
generate a patient care report using the output data.

17. The emergency responder communication system of claim 13, wherein the artificial intelligence model is further operative to generate the output data by:
performing entity extraction on the unstructured CAD incident data.

18. The emergency responder communication system of claim 13, wherein the artificial intelligence model is a large language model.

19. The emergency responder communication system of claim 13, wherein the artificial intelligence model is a generative pre-trained transformer (GPT) model.

20. The emergency responder communication system of claim 13, further comprising:
a virtual private cloud, operatively coupled to the cloud server, wherein the artificial intelligence model is hosted within the virtual private cloud.

21. A method comprising:
training an artificial intelligence module in a cloud-based emergency responder communication system using training data comprising computer-aided-dispatch (CAD) incident data from an emergency communication center (ECC);
generating a script, in response to the training data, by the artificial intelligence module, the script for converting CAD incident data into a format useable by an emergency responder mobile device terminal application; and
configuring a cloud-based processor using the script.

22. The method of claim 21, further comprising:
receiving CAD incident data, corresponding to a CAD incident at an emergency communication center (ECC), at a cloud server;
sending the CAD incident data and the script to an artificial intelligence model;
receiving output data from the artificial intelligence model in response to processing the CAD incident data in response to the script; and
sending the output data to an emergency responder mobile device terminal to provide information about the CAD incident.
